(19) United States
(12) Patent Application Publication
(10) Pub. No.: US 2016/0103533 A1
(43) Pub. Date: Apr. 14, 2016

(54) SYSTEM AND METHOD FOR PROVIDING A MULTIPLAYER TEXT-BASED GAME VIA AN INTERCONNECTED COMPUTER NETWORK

(71) Applicant: Stephanie Yinman Chan, Saratoga, CA (US)

(72) Inventor: Stephanie Yinman Chan, Saratoga, CA (US)

(21) Appl. No.: 14/509,205

(22) Filed: Oct. 8, 2014

(51) Int. Cl. G06F 3/048; A63F 13/30; A63F 13/798; A63F 13/33; A63F 13/61; A63F 13/795

(52) U.S. Cl. CPC G06F 3/048; A63F 13/61; A63F 13/795; A63F 13/798; A63F 13/33; A63F 13/30

(57) ABSTRACT

The present invention generally relates to games implemented on computing and/or mobile devices. Specifically, this invention relates to a system and method for providing a text-based game via one or more computing devices interconnected on a communications network, where users compete in the replication of text-based content displayed to the users simultaneously.

### FIELD OF THE INVENTION

The present invention generally relates to games implemented on computing and/or mobile devices. Specifically, this invention relates to a system and method for providing a text-based game via one or more computing devices interconnected on a communications network, where users compete in the replication of text-based content displayed to the users simultaneously.

### BACKGROUND OF THE INVENTION

Texting and communicating via text messages or other similar text based communications (e.g., social media postings) are ubiquitous. Individuals today communicate far more frequently via text based electronic communications than in person or via voice enabled communications means. This is especially true with younger individuals, who are likely to have been raised in an environment that was rarely without interconnectivity to their peers.

Individuals who communicate via text messaging or other text-based communications means frequently take pride in how fast they can generate text messages. Further, it has been shown that taking notes, or other repetitious activities, such as texting or typing, can cause internalization and learning of materials duplicated in this manner. In fact, it has been shown that taking notes involves individuals in a superior manner compared to visualization alone.

For instance, with respect to advertising, it has been shown that taking notes involves users in a superior way compared to advertising based on visual images alone as the portion copied by the user, generally a slogan or other catchphrase, is internalized through tactile feedback.

However, individuals are not likely to simply begin duplication of advertising slogans and catchphrases without purpose, leaving advertisers without a method for implementing the improved retention features that are accomplished through duplication through text or typing the slogan or other catchphrase.

While provision of gaming or game like interaction with these advertisements to individuals in conjunction with rewards based compensation methods, such as awarding prizes to the fastest or the most accurate duplicator, no such system exists to provide these features. Therefore, there is a need in the art for a system and method for providing a text-based game via one or more computing devices interconnected on a communications network, where users compete in the replication of text-based content displayed to the users simultaneously. These and other features and advantages of the present invention will be explained and will become obvious to one skilled in the art through the summary of the invention that follows.

### SUMMARY OF THE INVENTION

The present invention generally relates to games implemented on computing and/or mobile devices. Specifically, this invention relates to a system and method for providing a text-based game via one or more computing devices interconnected on a communications network, where users compete in the replication of text-based content displayed to the users simultaneously.

According to an embodiment of the present invention, a system providing a multiplayer text-based game via an interconnected computer network comprising: a processor, a memory, and a game module, wherein said processor, said memory, and said game module are communicatively connected and configured to: receive game input data from an advertiser; generate a multiplayer text-based game from said game input data; receive game play requests from a plurality of players; assign said plurality of players to play said multiplayer text-based game; receive gameplay data from each of said plurality of players, wherein said gameplay data is related to said multiplayer text-based game; rank said plurality of players based at least in part on said gameplay data; and provide rewards to at least a subset of said plurality of players based on said ranking.

According to an embodiment of the present invention, the processor, the memory, and the game module are further configured to: verify said game input data is valid for said multiplayer text-based game; receive game parameters and reward parameters from said advertiser; and associate said game parameters and reward parameters with said multiplayer text-based game.

According to an embodiment of the present invention, the processor, the memory, and the game module are further configured to identify each player of said plurality of players via information provided by said player.

According to an embodiment of the present invention, the processor, the memory, and the game module are further configured to: retrieve information about each player of said plurality of players; match each of said players to said advertiser, wherein the assignment of players to said multiplayer text-based game is based on said matching.

According to an embodiment of the present invention, the processor, the memory, and the game module are further configured to: validate said multiplayer text-based game prior to gameplay; and validate game response data prior to ranking said plurality of players.

According to an embodiment of the present invention, the processor, the memory, and the game module are further configured to confirm game ready status of each player of said plurality of players prior to gameplay.

According to an embodiment of the present invention, a method of providing a multiplayer text-based game via an interconnected computer network includes the steps of: receiving game input data from an advertiser; generating a multiplayer text-based game from said game input data; receiving game play requests from a plurality of players; assigning said plurality of players to play said multiplayer text-based game; receiving gameplay data from each of said plurality of players, wherein said gameplay data is related to said multiplayer text-based game; ranking said plurality of players based at least in part on said gameplay data; and providing rewards to at least a subset of said plurality of players based on said ranking.

According to an embodiment of the present invention, the method further includes the steps of: verifying said game input data is valid for said multiplayer text-based game; receiving game parameters and reward parameters from said advertiser; and associating said game parameters and reward parameters with said multiplayer text-based game.

According to an embodiment of the present invention, the method further includes the steps of identifying each player of said plurality of players via information provided by said player.

According to an embodiment of the present invention, the method further includes the steps of: retrieving information about each player of said plurality of players; matching each of said players to said advertiser, wherein the assignment of players to said multiplayer text-based game is based on said matching.

According to an embodiment of the present invention, the method further includes the steps of: validating said multiplayer text-based game prior to gameplay; and validating game response data prior to ranking said plurality of players.

According to an embodiment of the present invention, the method further includes the steps of confirming game ready status of each player of said plurality of players prior to gameplay.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 shows a block diagram of the system with various hardware components and functional modules according to an embodiment of the present invention.

FIG. 2 is a network diagram showing various components of the system and interaction therewith, in accordance with an embodiment of the present invention.

FIG. 3 is a network diagram showing various components of the system and interaction therewith, in accordance with an embodiment of the present invention.

FIG. 4 is a flow chart of an exemplary process showing interaction with an advertiser in accordance with an embodiment of the present invention.

FIG. 5 is a flow chart of an exemplary process showing interaction with a player in accordance with an embodiment of the present invention.

FIG. 6 is a flow chart of an exemplary process showing execution of a text based game in accordance with an embodiment of the present invention.

FIGS. 7-7A are illustrations of a text based game in accordance with an exemplary embodiment of the present invention.

FIGS. 8-15 are illustrations of graphical user interfaces (GUI) used in conjunction with a text based game in accordance with an exemplary embodiment of the present invention.

### DETAILED SPECIFICATION

The present invention generally relates to games implemented on computing and/or mobile devices. Specifically, this invention relates to a system and method for providing a text-based game via one or more computing devices interconnected on a communications network, where users compete in the replication of text-based content displayed to the users simultaneously.

According to embodiments of the present invention, the system described herein is configured to provide a multiplayer text based game to the computing devices of remote players via a software as a service (SAAS) model. The system provides content and data to a plurality of computing devices and receives response data from the various computing devices such that the system affects competitive gameplay between players. In preferred embodiments, the system may be further configured to verify the validity of data received from one or more players in order to ensure fair play. Further, preferred embodiments of the system are configured to provide a rewards system, whereby players can be rewarded for their competitive efforts. These and other features are detailed further below.

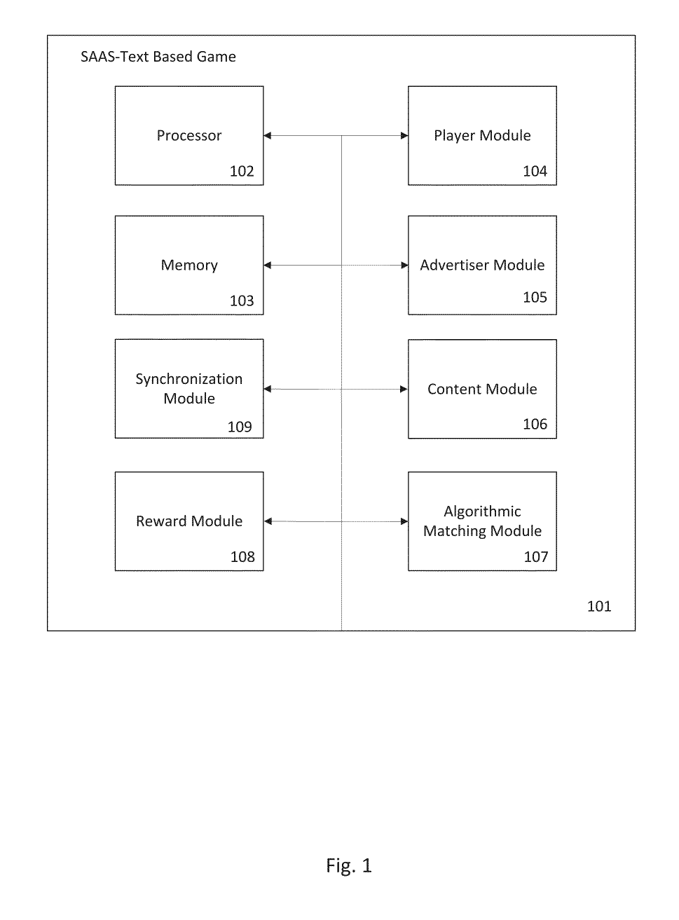

Turning to FIG. 1, a block diagram of an exemplary embodiment of the system 101 is shown, including functional modules for providing synchronization, rewards, player matching and content storage/organization. The functional system includes a processor 102 and a memory 103 which are communicatively connected to each other and to various functional blocks, including a Player Module 104, an Advertiser Module 105, a Content Module 106, an Algorithmic Matching Module 107, a Reward Module 108 and a Synchronization module 109. A Communication Module or other communications means may also be included for communication with third party auxiliary service providers and/or with users of the system 101. These Modules may be implemented in hardware, software, or a combination of both. In certain embodiments, these modules may be combined into fewer modules or expanded into additional modules. For instance, modules may be combined into a single game module which comprises each of the Player Module 104, Advertiser Module 105, Content Module 106, Algorithmic Matching Module 107, Reward Module 108 and Synchronization module 109. One of ordinary skill in the art would appreciate that there are numerous combinations of modules that could be utilized, and embodiments of the present invention are contemplated for use with any combination of modules.

According to an embodiment of the present invention, the Player Module 104, is configured to provide functionality with respect to interactions with a plurality of players that utilize the system. Features of the Player Module 104 may include, but are not limited to, registering new players, tracking game play and progress among the players, leaderboard information, reward point status, historical game play data, player identification information, or any combination thereof. One of ordinary skill in the art would appreciate that there are numerous functions that could be provided by the Player Module 104, and embodiments of the present invention are contemplated for use with any appropriate Player Module 104 functionality.

According to an embodiment of the present invention, the Advertiser Module 105, is configured to provide functionality with respect to interactions with one or more advertisers that utilize the system. Features of the Advertiser Module 105 may include, but are not limited to, registering new advertisers, submission, editing and storing of advertising content, submission, editing and storing of game content (e.g., slogans, logos), advertiser identification information, advertiser administrative control information (e.g., authorized administrators and other role/function based permissions for advertisers), account information (e.g., credit balance, payment information), or any combination thereof. One of ordinary skill in the art would appreciate that there are numerous functions that could be provided by the Advertiser Module 105, and embodiments of the present invention are contemplated for use with any appropriate Advertiser Module 105 functionality.

According to an embodiment of the present invention, the Content Module 106 is configured to allow for the storage, retrieval and provision of game and other content to both advertisers and players as required. The content module is generally effected in a combination of both hardware and software and allows for the electronic storage, retrieval, organization and other functionality with respect to data utilized by the system. In many cases, the Content Module 106 will work in conjunction with other modules (e.g., Player Module 104, Advertiser Module 105) in order to provide data storage and retrieval functionality. In a preferred embodiment, one of the main functionalities of the Content Module 106 is the on demand provision of game content to the plurality of players of a game as described herein, most of the time this will be accomplished in conjunction with the communications means or communications module. One of ordinary skill in the art would appreciate that there are numerous functions that could be provided by the Content Module 106, and embodiments of the present invention are contemplated for use with any appropriate Content Module 106 functionality.

According to an embodiment of the present invention, the Algorithmic Matching Module 107 is configured to ensure appropriate matching of players of a specific game. In a preferred embodiment, the Algorithmic Matching Module 107 is configured to match players on one or more metrics in order to ensure that games provided by the system provide a certain level of competitiveness and enjoyment to the players. For instance, matching players on historical data, such as average rate of typing, win/loss ratios and leaderboard data, can lead to more enjoyable games as the players can be matched such that each game is competitive. This will eliminate or reduce the chance that certain players get discouraged by always being matched with other players of vastly different skill levels, creating either frustration or boredom in the players.

According to an embodiment of the present invention, the Reward Module 108 is configured to manage and control rewards provided by the system to the players. In preferred embodiments, rewards are offered by the system and funded by the advertisers and provided to players. The Reward Module 108 is configured to process both the formation of rewards as paid into the system via the advertisers as well as affect the recordation and payout of rewards to the players, generally for winning and/or playing the games provided by the system. Rewards may be used in conjunction with goods and services offered by the system or offered by third-party businesses that either connect to the system for confirmation and payment via rewards (e.g., reward points) or the system may transfer rewards to third-party systems. Generally, connection, payment, transfer and confirmation by and between the third-parties and the system may be affected by one or more communications means, such as through an Application Programming Interface (API) accessed via one or more networks (e.g., the Internet). One of ordinary skill in the art would appreciate that there are numerous functions that could be provided by the Reward Module 108, and embodiments of the present invention are contemplated for use with any appropriate Reward Module 108 functionality.

According to an embodiment of the present invention, the Synchronization Module 109 is an optional module that is configured to provide game play synchronization features amongst the players for games utilizing synchronization as one of its verification means to prevent cheating or other inappropriate activity with respect to the system. In other embodiments, the Synchronization Module 109 may be used to detect connectivity amongst players. Since the game is played via a plurality of players interconnected via networks that are subject to availability, the Synchronization Module 109 can be used to determine if one or more players lose connectivity during gameplay. When loss of connectivity occurs, the game can be suspended briefly, terminated or allowed to continue with the remaining players. One of ordinary skill in the art would appreciate that there are numerous functions that could be provided by the Synchronization Module 109, and embodiments of the present invention are contemplated for use with any appropriate Synchronization Module 109 functionality.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

In an exemplary embodiment according to the present invention, data may be provided to/from the players in communication with the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs to each other and/or to the players various mobile or other computing devices. One of ordinary skill in the art would appreciate that there are numerous manners in which the system could be configured and embodiments of the present invention are contemplated for use with any configuration.

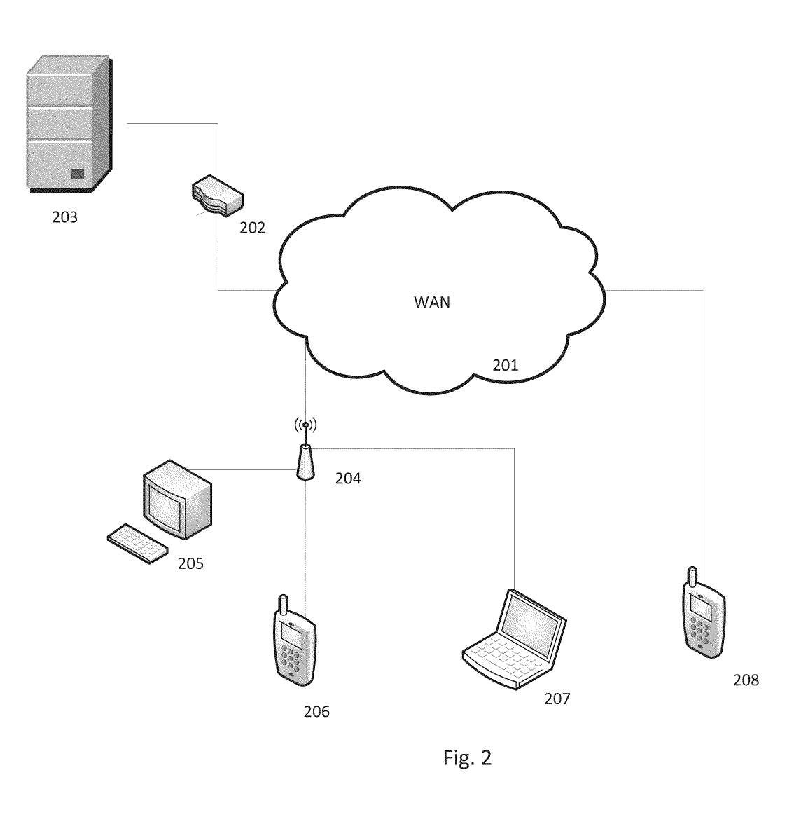

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device apparatus directly connected to the WAN (or via a wireless connection means such as CDMA, GSM, 3G, 4G) 206, ii) through a computing device 208, 209, 210 connected to a wireless access point 207 or iii) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

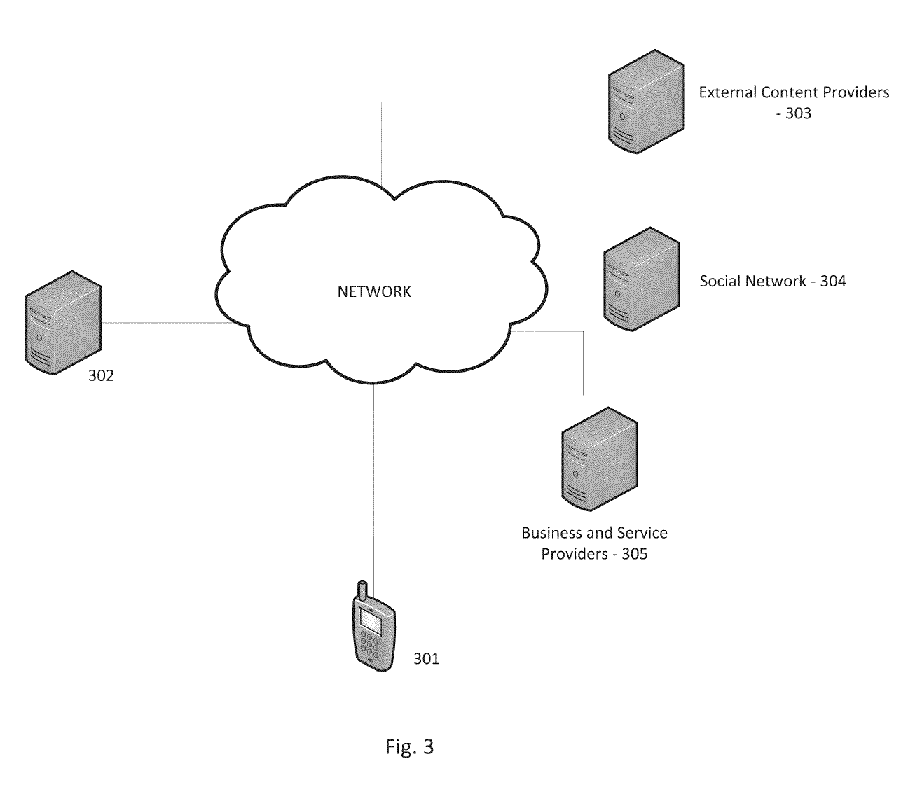

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of an external content provider API/website or other third party system 303, a social network 304, one or more business and service providers 305 or any combination thereof. Additionally, application server 302 may be able to enhance or otherwise provide additional services to an external content provider API/website or other third party system 303, a social network 304, or one or more business and service providers 305 by providing information to those entities that is stored on a database that is connected to the application server 302. One of ordinary skill in the art would appreciate how accessing one or more third-party systems could augment the ability of the system described herein, and embodiments of the present invention are contemplated for use with any third-party system.

With respect to gameplay, preferred embodiments of the system are configured to provide a text based game where players are provided a text phrase that will be displayed on a display element of their computing device and the players will be required to type or text the displayed text phrase and commit the transmission of the text or typing to the system. In preferred embodiments, the system will reward the players based on the speed and accuracy of the text or typing provided.

According to an embodiment of the present invention, the players may be required to provide responses to one or more phrases before completing a single game. For instance, players may be ranked by total number of wins or other placements (e.g., 1^{st}, 2^{nd}, 3^{rd}), with the highest ranking overall player being determined the winner. Further, rewards may be offered on various metrics, such as winner-takes-all or tiered points (e.g., 1^{st} place gets the most rewards and each subsequent place receives fewer points).

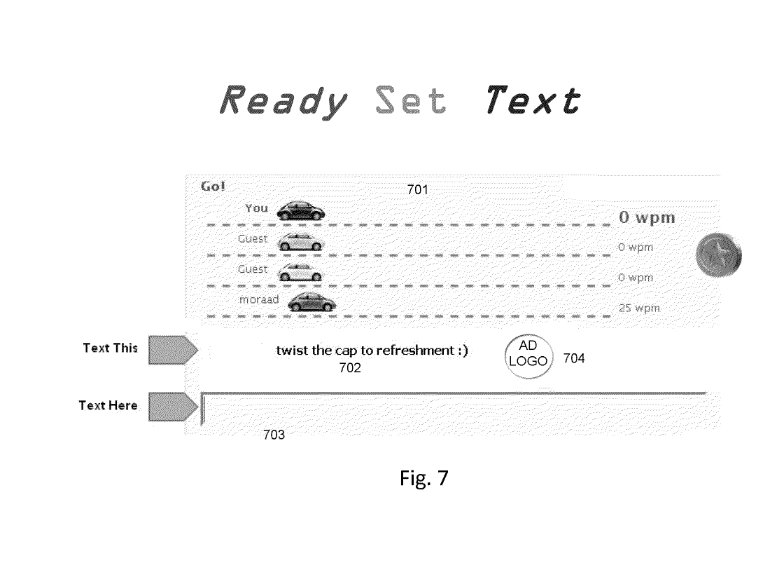

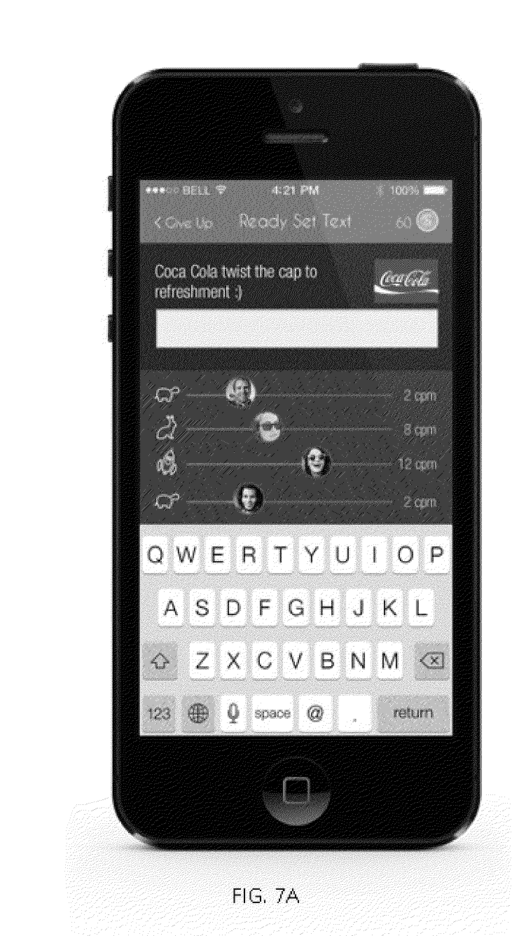

FIGS. 7-7A show exemplary embodiments of a graphical user interface provided to a mobile computing device of a player, in accordance with an embodiment of the present invention. Progress in the game is represented by a graphical progress indicator 701. Text to be typed 702 is shown above the response field 703. An optional advertiser logo space 704 is shown as well, where the logo or other information associated with an advertiser can be shown. The game may be offered directly from the system or through third-party providers (e.g., social media networks), with data being provided through the third-party providers via interactions with the system (e.g., via an API).

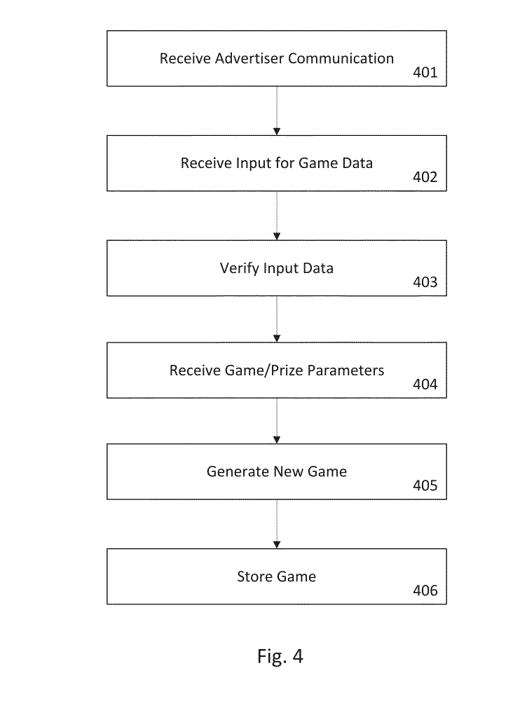

Turning now to FIG. 4, an exemplary process showing interaction with an advertiser in accordance with an embodiment of the present invention. The process starts at step 401 with the receipt of communications from an advertiser. In this example, the advertiser is configuring a new game and the system, at step 402, receives game data from the advertiser. Game data may include text to be typed, advertising content to be displayed along with the game content (e.g., logos, background images, hypertext links, images, graphics, video or other content or any combination thereof. In the case where multiple rounds are to be played, the advertiser can provide multiple game data content for use in the provision of the game.

At step 403, the system verifies the game data input by and received from the advertiser. The system may be configured to validate that the game data does not violate parameters set by the system (e.g., length restrictions, content restrictions, vulgarity) and that the game data is capable of being utilized by the system for provision of a game. Further, the system may validate that the received game data is from the advertiser, such as through use of secured channels of transmission or through two-factor authentication means. One of ordinary skill in the art would appreciate that there are numerous methods for validating the game data, and embodiments of the present invention are contemplated for use with any appropriate validation means.

Once the game data has been verified, the system will receive information related to game and prize parameters at step 404. Game parameters may include for what duration the game is to be presented to players, prize size and type to be offered, maximum amount of prizes to be awarded, restrictions (if any) on players (e.g., US only, not permitted in various states, only certain age groups) or any combination thereof. For instance, an advertiser may set a game that is to be played only during a holiday season by restricting the play dates between a specified date range. In another example, an advertiser may restrict the age range of players to those appropriate for the goods/services provided by the advertiser (e.g., alcohol advertisements to those players 21+, toy advertisements to those between the target audience range). One of ordinary skill in the art would appreciate that there are numerous parameters that could be used in conjunction with a game, and embodiments of the present invention are contemplated for use with any appropriate parameters.

Once the parameters have been input, the system will generate the game at step 405, based on the verified input data and parameters. Once the game is generated, the system can store the game for play, based upon the parameters received and processed by the system (step 406). At this point, the game is ready to be played.

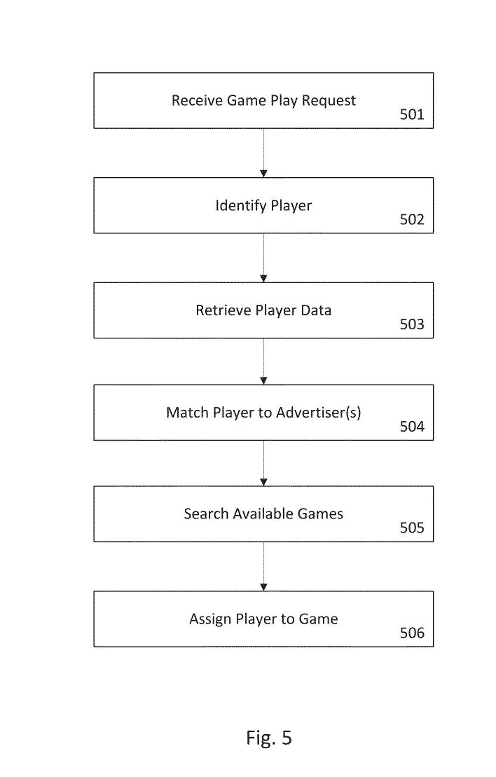

FIG. 5 is a flow chart of an exemplary process showing interaction with a player in accordance with an embodiment of the present invention. The process starts with a player sending, and the system receiving a game play request (step 501). At step 502, the system identifies the player via a logon or other authentication method. Optionally, if this is the first time a player has used the system, the system may register the player by requesting identification information from the user (e.g., name, username, password, email address, physical address).

At step 503, the system retrieves player data for use in determining what games should are appropriate for the user. This may include player information identifying characteristics of the player, such as age, gender, sex, interests, past games played, device type, and any combination thereof. One of ordinary skill in the art would appreciate that there are numerous data points that could be used in making such determinations, and embodiments of the present invention are contemplated for use with any such data point related to player information.

At step 504, the system matches the player to one or more advertisers based at least in part on the player data retrieved in the previous step. As noted, matching generally includes pairing players that have common data points with the advertisers. In one embodiment, the more data points that sync up between the player and advertiser, the more likely the system is to match the player and advertiser. In other embodiments, multiple criterion may be utilized to affect the matching of players and advertisers, including advertiser's budget and expenditure portfolio (e.g., advertisers with larger budgets may get picked more frequently than those with lower budgets in order to ensure expenditure of the budget over the expenditure portfolio, such as the duration of the game specified by the advertiser), express interest in an advertiser received from a player (e.g., player picks advertisers they are interested in via a GUI provided to the player), or matching the player with active games awaiting more players, or any combination thereof. One of ordinary skill in the art would appreciate that there are numerous criterion that could be used with embodiments of the present invention, and embodiments of the present invention are contemplated for use with any appropriate criterion.

At step 505, the system searches for active games in which game content from matched advertisers are currently being played. For any given advertiser, there may be one or more games running currently on the same game content. Each game may have two or more players competing against each other. If no open games are available, the system may generate a new game room for the player and place the player in a queue to wait for additional players to join. Once the current available game list is provided, at step 506, the player is entered into a game that matched the search criteria or entered into a new game queue to wait for additional players.

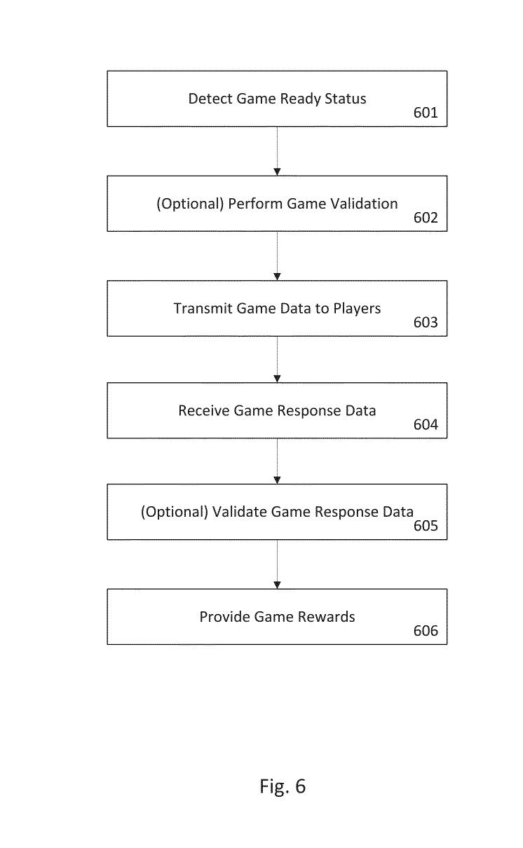

Turning now to FIG. 6, a flow chart of an exemplary process showing execution of a text based game in accordance with an embodiment of the present invention. The process starts by the system detecting a game ready status from each player of the game. The game ready status could be indicated by communications from each player that they are ready to begin, such as by a player clicking a command or icon on a GUI displayed on the player's computing device. In other embodiments, software components on a computing device of the player may communicate that the game is ready to be played without interaction by the player, such game ready signal being deterministic of the underlying computing device's readiness and not necessarily the readiness of the player.

Optionally, at step 602, the system can confirm validation of various aspects of the game prior to beginning game play. For instance, the system may validate software of the player's computing devices, such as confirmation that the players are using the appropriate version of the game software (if any), the system may validate connections are established with the player's devices, the system may validate that the identified game is available and capable of being played (e.g., enough rewards exist to reward players for the gameplay), the system may validate that the players are qualified to play and appropriately signed in or otherwise credentialed, or any combination thereof. One of ordinary skill in the art would appreciate that there are numerous validations that could be utilized with embodiments of the present invention, and embodiments of the present invention are contemplated for use with any appropriate validation method and means.

At step 603, game date is transmitted to each of the players. At this time, the players are allowed to play the game. The players will type or otherwise enter the text response data into their respective computing devices and submit their response when complete. At step 604, the players have completed the gameplay (or at least a first round of the game) and the response data is received at the system. Response data may include the raw typed data, game result data as processed by the computing device of the players, or any combination thereof.

For instance, in certain embodiments, the players may submit their raw response data (e.g., raw typed text) which will be processed by the system to determine actual type rate and accuracy. In these embodiments, the system may be configured to take into account information known about the player's computing device and connection to accurately assess the raw data. For instance, the system may account for the lag time causes by the time it takes to send and receive responses between the system and the computing device of the player over a network connection by calculating the time it takes for packets to travel between the two (i.e., ping).

In other embodiments, the system may rely on processed data received from the various computing devices of the players. In these embodiments, the computing devices of the player process the type rate and accuracy and send this information to the system which will prepare results of the game based on data received from all reporting computing devices.

In further embodiments, the system may receive both raw data and processed data. In these embodiments, the system can use the processed data for preparing results, but also can use the raw data to confirm or identify any suspect responses. In line with optional step 605, the system may validate data received from the players, whether raw, processed or both, one or more validation metrics. For instance, the system may validate the processed data by checking to see if the data is inconsistent with the raw data received or if the data is inconsistent with physical limitations (e.g., processed data shows abnormally high type rate, processed data indicates a type rate that could not have occurred given elapsed time between transmission of game data and receipt of processed data) or other limitations. One of ordinary skill in the art would appreciate that there are numerous ways to validate game response data, and embodiments of the present invention are contemplated for use with any appropriate validation methods and means.

After the system has processed game data (and optionally validation), the system provides the appropriate game rewards to the players at step 606. In preferred embodiments, players can be rewarded as described herein, and the rewards may recorded by the system and stored for later consumption/redemption by the players and simultaneously reported to the players via transmission of reward information to the various computing devices of the players. Reward information may be displayed on the various computing devices of players via a GUI or other graphical or textual representation. At this point, the process will terminate.

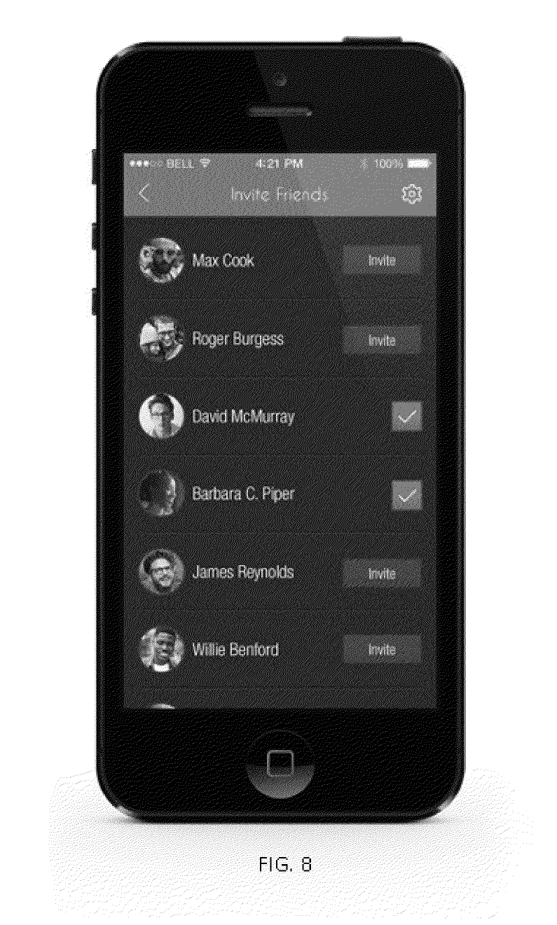

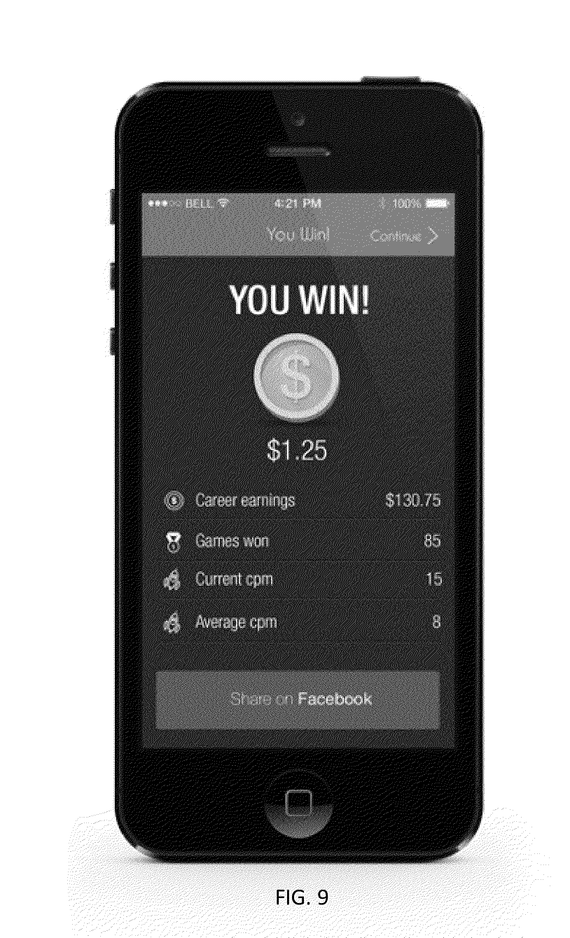

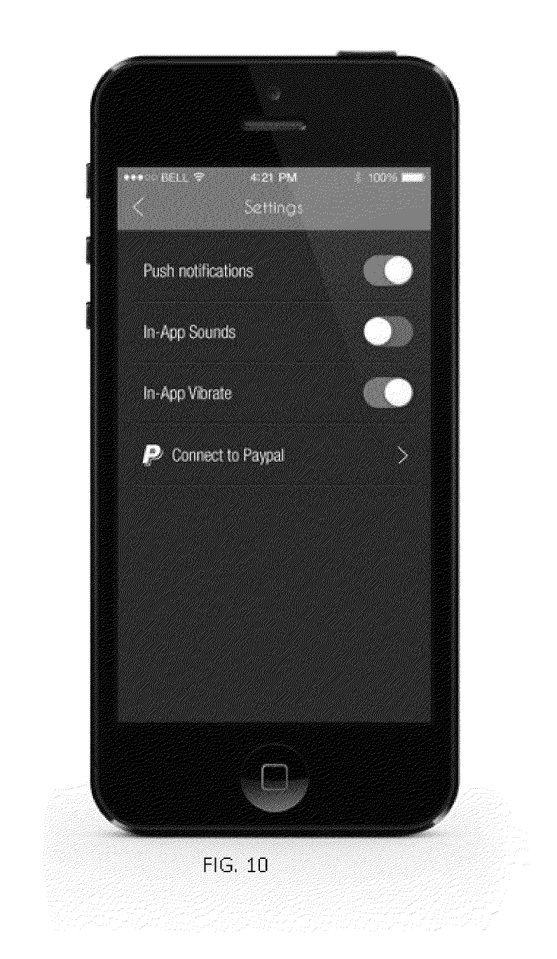

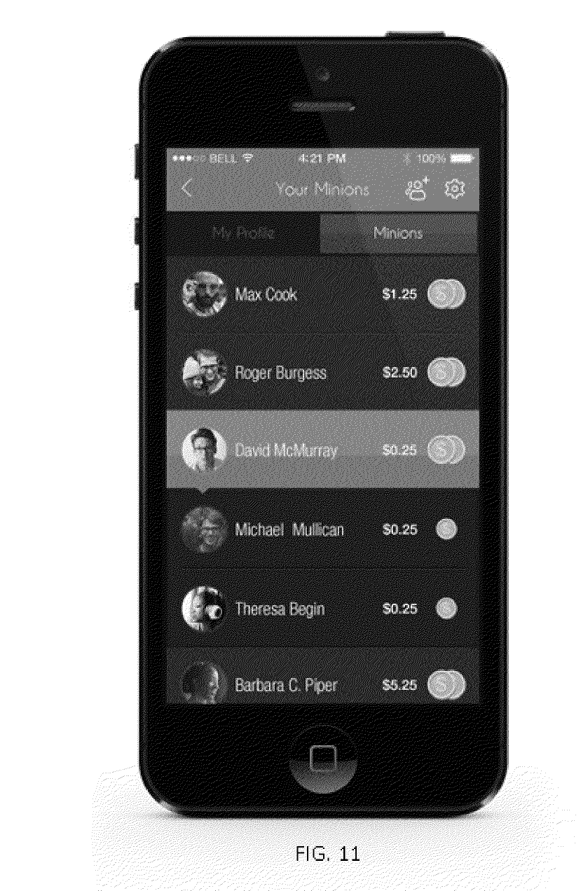

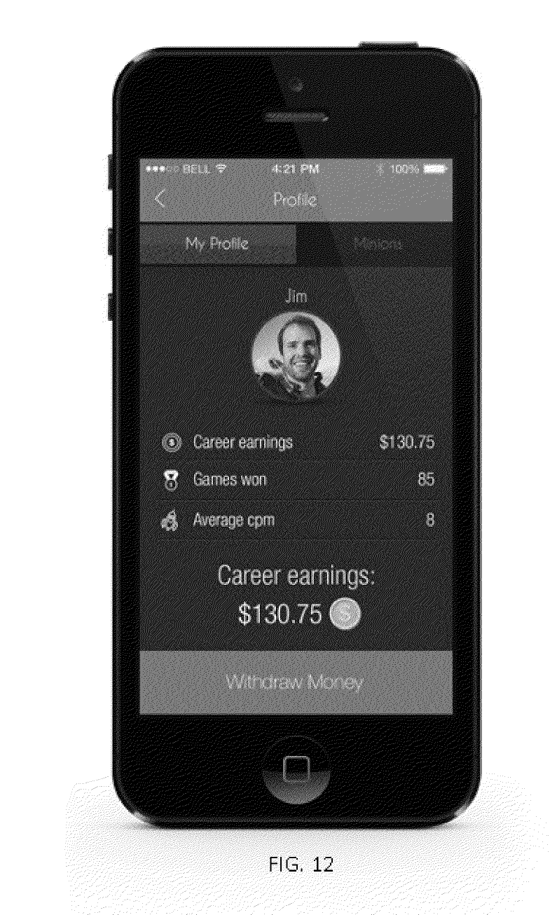

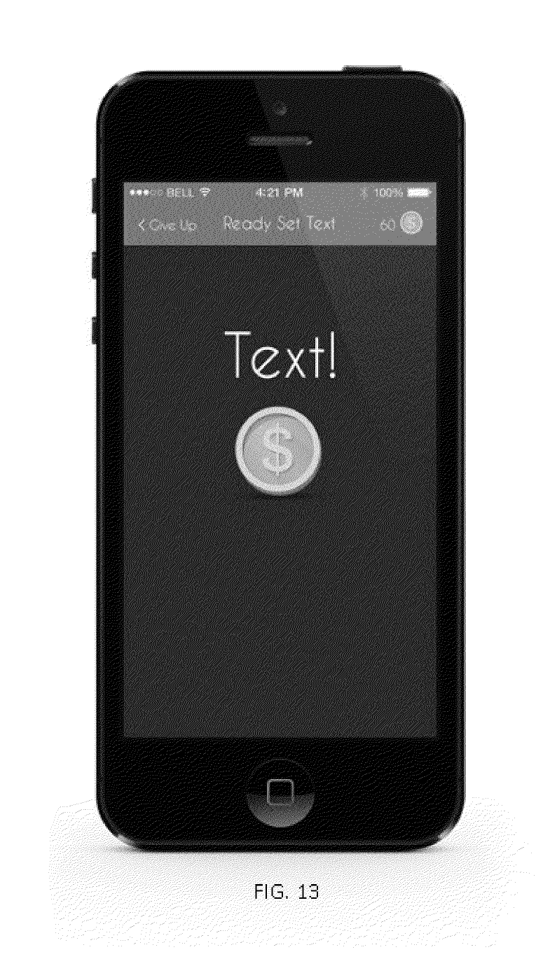

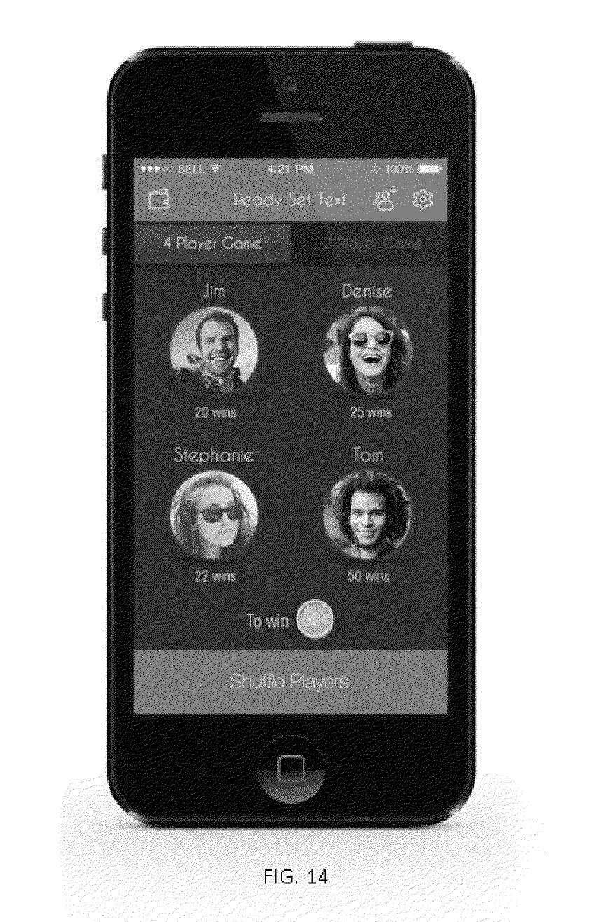

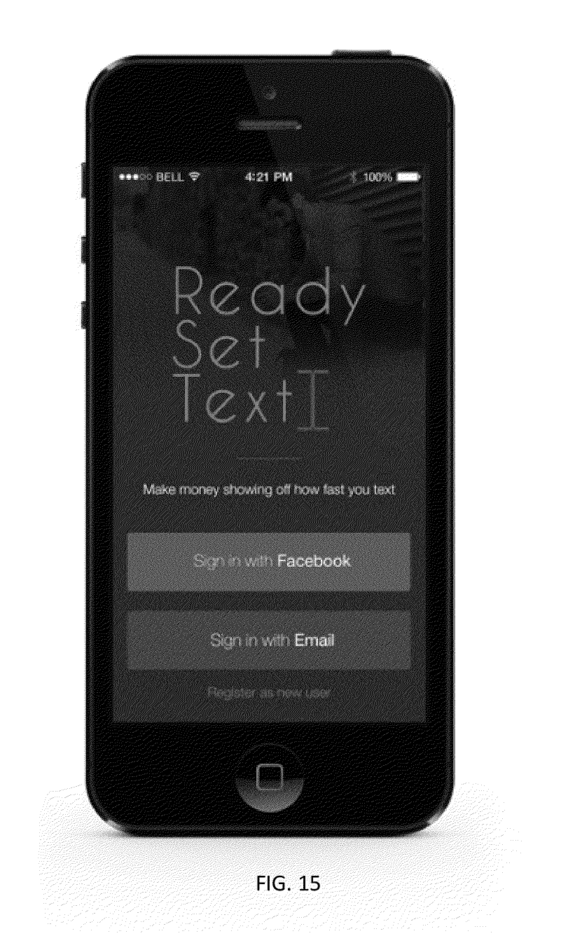

FIGS. 8-15 are illustrations of graphical user interfaces (GUI) used in conjunction with a text based game in accordance with an exemplary embodiment of the present invention. Each of these figures shows exemplary embodiments of the game process in one or more states as well as features of the text-based game in use on the computing devices of players.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system providing a multiplayer text-based game via an interconnected computer network comprising:
a processor,
a memory, and
a game module,
wherein said processor, said memory, and said game module are communicatively connected and configured to:
receive game input data from an advertiser;
generate a multiplayer text-based game from said game input data;
receive game play requests from a plurality of players;
assign said plurality of players to play said multiplayer text-based game;
receive gameplay data from each of said plurality of players, wherein said gameplay data is related to said multiplayer text-based game;
rank said plurality of players based at least in part on said gameplay data; and
provide rewards to at least a subset of said plurality of players based on said ranking.

2. The system of claim 1, wherein said processor, said memory, and said game module are further configured to:
verify said game input data is valid for said multiplayer text-based game;
receive game parameters and reward parameters from said advertiser; and
associate said game parameters and reward parameters with said multiplayer text-based game.

3. The system of claim 1 wherein said processor, said memory, and said game module are further configured to identify each player of said plurality of players via information provided by said player.

4. The system of claim 3 wherein said processor, said memory, and said game module are further configured to:
retrieve information about each player of said plurality of players;
match each of said players to said advertiser, wherein the assignment of players to said multiplayer text-based game is based on said matching.

5. The system of claim 1, wherein said processor, said memory, and said game module are further configured to:
validate said multiplayer text-based game prior to gameplay; and
validate game response data prior to ranking said plurality of players.

6. The system of claim 1, wherein said processor, said memory, and said game module are further configured to:
confirm game ready status of each player of said plurality of players prior to gameplay.

7. A method of providing a multiplayer text-based game via an interconnected computer network comprising the steps of:
receiving game input data from an advertiser;
generating a multiplayer text-based game from said game input data;
receiving game play requests from a plurality of players;
assigning said plurality of players to play said multiplayer text-based game;
receiving gameplay data from each of said plurality of players, wherein said gameplay data is related to said multiplayer text-based game;
ranking said plurality of players based at least in part on said gameplay data; and
providing rewards to at least a subset of said plurality of players based on said ranking.

8. The method of claim 7 further comprising the steps of:
verifying said game input data is valid for said multiplayer text-based game;
receiving game parameters and reward parameters from said advertiser; and
associating said game parameters and reward parameters with said multiplayer text-based game.

9. The method of claim 7 further comprising the step of identifying each player of said plurality of players via information provided by said player.

10. The method of claim 10 further comprising the steps of:
retrieving information about each player of said plurality of players;
matching each of said players to said advertiser, wherein the assignment of players to said multiplayer text-based game is based on said matching.

11. The method of claim 7 further comprising the steps of:
validating said multiplayer text-based game prior to gameplay; and
validating game response data prior to ranking said plurality of players.

12. The method of claim 7 further comprising the step of confirming game ready status of each player of said plurality of players prior to gameplay.
